(19) United States
(12) Patent Application Publication
(10) Pub. No.: US 2022/0064502 A1
(43) Pub. Date: Mar. 3, 2022

(54) INSULATED WIRE WITH BONDING LAYER

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Toyoki FURUKAWA, Mie (JP); Yuta YASUYOSHI, Mie (JP)

(21) Appl. No.: 17/416,687

(22) PCT Filed: Dec. 5, 2019
(86) PCT No.: PCT/JP2019/047565

§ 371 Date: Jun. 21, 2021

(30) Foreign Application Priority Data
Dec. 25, 2018 (JP) 2018-240720

(51) Int. Cl. C09J 123/26; H01B 3/44; H01B 7/40; C09D 127/06; C09D 123/14; C09J 7/35

(52) U.S. Cl. CPC C09J 123/26; H01B 3/448; H01B 7/40; C09D 127/06; C09J 2203/326; C09J 7/35; C09J 2423/10; C09J 2467/00; C09J 2203/302; C09D 123/14

(57) ABSTRACT

Provided is an insulated wire with bonding layer having a bonding layer with excellent adhesive strength on both an insulating coating layer and an adherend as an outer layer. An insulated wire 1 with bonding layer has a conductor 2, an insulating coating layer 3 covering an outer circumference of the conductor 2, and a bonding layer 4 provided on an outer side of the insulating coating layer and for bonding by heat, the bonding layer 4 containing (A) a modified polyolefin, and (B) one or more materials selected from a polyester resin and a polyester elastomer, and the bonding layer 4 containing 10 to 70 parts of the (B) component per 100 parts total of the (A) and (B) components.

### TECHNICAL FIELD

The present disclosure relates to an insulated wire with bonding layer, and more specifically to an insulated wire with bonding layer having a bonding layer with thermal bonding properties on the outer side of an insulating coating that covers a conductor.

### BACKGROUND

Vehicles such as automobiles and electrical and electronic devices use a large number of insulated wires having a conductor and an insulating coating that covers the outer circumference of the conductor. In recent years, the number of insulated wires that are used has been increasing as automobiles and electrical and electronic devices become increasingly high performance. Conventionally, such insulated wires have been used by being fixed to the body of an automobile, the casing of a device or the like, using fixing hardware such as clamps. However, due to the increasing number of insulated wires that are used, the space occupied by fixing hardware and the like is increasing, and space saving is sought.

To address the above problem, use of an insulated wire having a bonding layer consisting of a modified polyolefin on the outer circumference, such as disclosed in Patent Document 1, for example, enables the insulated wire to be fixed directly to the body, casing or the like via the bonding layer without using fixing hardware or the like, and is effective for space saving.

### PRIOR ART DOCUMENT

### Patent Document

Patent Document 1: JP 2002-237219A

### SUMMARY OF THE INVENTION

### Problems to be Solved

Conventionally, a polyvinyl chloride composition is often used as the material for the insulating coating that covers the outer circumference of the conductor. The bonding layer is provided on the outer side of the insulating coating layer of the insulated wire so as to contact the insulating coating layer, but there is a problem in that polyvinyl chloride, which is often used for the insulating coating, has a weak adhesive strength on the modified polyolefin constituting the bonding layer of Patent Document 1, and delamination tends to occur at the interface between the insulating coating layer and the bonding layer. If the interface between the insulating coating layer and the bonding layer delaminates when a load is applied to the wire, the load is concentrated on the bonding layer on the outer side, and the adhesive strength of the entire wire decreases.

Also, although delamination at the interface between the insulating coating layer and the bonding layer such as described above is less likely to occur in the case where the insulating coating does not contain polyvinyl chloride, it is sought to improve the adhesive strength between the bonding layer and an adherend, for the purpose of stably holding the insulated wire with bonding layer on an adherend such as the body of an automobile, the casing of a device or the like.

In view of the above problem, the present disclosure aims to provide an insulated wire with bonding layer having a bonding layer that has excellent adhesive strength on both an insulating coating layer and an adherend as an outer layer.

### Means to Solve the Problem

An insulated wire with bonding layer of the present disclosure has a conductor, an insulating coating layer covering an outer circumference of the conductor, and a bonding layer provided on an outer side of the insulating coating layer and for bonding by heat, the bonding layer containing (A) a modified polyolefin and (B) one or more materials selected from a polyester resin and a polyester elastomer, and the bonding layer containing 10 to 70 parts of the (B) component per 100 parts total of the (A) and (B) components.

### Effect of the Invention

According to the insulated wire with bonding layer of the present disclosure, the bonding layer has excellent adhesive strength on both the insulating coating layer and the adherend.

### BRIEF DESCRIPTION OF THE DRAWINGS

FIG. 1 is a perspective view showing an outward appearance of an insulated wire with bonding layer according to the present disclosure.

FIG. 2 is a sectional view taken along A-A in FIG. 1.

FIG. 3 is a sectional view in which the insulated wire with bonding layer according to the present disclosure is bonded to an adherend.

FIG. 4 is a sectional view in which two insulated wires with bonding layer according to the present disclosure are bundled and bonded.

FIGS. 5A and 5B are diagrams showing a method of evaluating the adhesive strength of the insulated wire with bonding layer. FIG. 5A shows a method of bonding an insulated wire with bonding layer to an adherend, and FIG. 5B shows a method of a peeling test of the insulated wire with bonding layer.

### DETAILED DESCRIPTION TO EXECUTE THE INVENTION

### Description of Embodiments of Disclosure

Modes of the present disclosure will initially be enumerated and described.

(1) An insulated wire with bonding layer of the present disclosure has a conductor, an insulating coating layer covering an outer circumference of the conductor, and a bonding layer provided on an outer side of the insulating coating layer and for bonding by heat, the bonding layer containing (A) a modified polyolefin and (B) one or more materials selected from a polyester resin and a polyester elastomer, and the bonding layer containing 10 to 70 parts of the (B) component per 100 parts total of the (A) and (B) components.

According to the insulated wire with bonding layer of the present disclosure, a bonding layer with thermal bonding properties containing (A) a modified polyolefin and (B) one or more materials selected from a polyester resin and a polyester elastomer is provided, thus enabling the insulated wire with bonding layer to be stably held with respect to an adherend, even in the case where the insulating coating layer contains polyvinyl chloride, given the excellent adhesive strength between the insulating coating layer and the bonding layer, and also the excellent adhesive strength between the adherend and the bonding layer.

When the adhesive strength between the insulating coating layer and the bonding layer is insufficient, delamination occurs at the interface between the insulating coating layer and the bonding layer when a load is applied to the wire, and the load is concentrated on the bonding layer that is directly adhered to the adherend. Furthermore, the bonding layer is stretched and tears where the layer becomes thin, and the wire detaches from the adherend. Given that the wire with bonding layer of the present disclosure has excellent adhesive strength between the insulating coating layer and the bonding layer, the load is distributed throughout the wire, without the bonding layer being stretched in places, and thus the wire is less likely to become detached.

(2) The insulating coating layer may contain a polyvinyl chloride. Although bonding layers commonly used heretofore had poor adhesive strength on an insulating coating layer containing polyvinyl chloride, the bonding layer according to the present disclosure has excellent adhesive strength on an insulating coating layer containing polyvinyl chloride, and the effect achieved by the present disclosure is marked.

(3) The bonding layer preferably contains (A) the modified polyolefin and (B) the polyester resin. When the (B) component contains polyester resin, the adhesive strength on the insulating coating layer is excellent.

(4) The bonding layer preferably contains (A) the modified polyolefin and (B) the polyester elastomer. When the (B) component contains polyester elastomer, flexibility is excellent.

(5) The bonding layer preferably is provided around an entire circumference in a circumferential direction on the outer side of the insulating coating layer. This is because the adhesion area between the bonding layer and the insulating coating layer increases. This is also because the bonding layer will be circular in cross-section, and thus, even supposing that the bonding layer and the insulating coating delaminate, the wire can be retained without immediately becoming detached.

### Detailed Embodiments of Disclosure

Specific examples of an insulated wire with bonding layer of the present disclosure will be described below with reference to the drawings. Note that the disclosure is not limited to these illustrative examples.

An insulated wire 1 with bonding layer has an insulated wire having a conductor 2 and an insulating coating layer 3 covering the outer circumference of the conductor 2, and, furthermore, on the outer side thereof, has a bonding layer 4 containing (A) a modified polyolefin and (B) one or more materials selected from a polyester resin and a polyester elastomer. The bonding layer 4 softens and bonds at a lower temperature than the heat resistant temperature of the insulating coating layer 3.

The bonding layer 4 contains (A) a modified polyolefin. The (A) component constituting the bonding layer 4 is a polyolefin into which functional groups have been introduced by copolymerizing or graft polymerizing a base polyolefin derived from α-olefin as a monomer with a polymerizable monomer having functional groups such as the carboxyl group, ester group and acid anhydride group. Due to introducing these functional materials, the adhesive strength on the adherend 5 is excellent at the time of bonding. When the modified polyolefin has the acid anhydride group, the adhesive strength is particularly excellent. One type of modified polyolefin may be used alone, or two or more types may be used in combination.

The melting point of the (A) component is preferably not more than 185° C., and more preferably not more than 160° C. When the melting point is 185° C. or less, an increase in the softening point of the bonding layer 4 can be suppressed, and deterioration of the conductor 2 or the insulating coating layer 3 due to heat generated when bonding is performed is less likely to occur. On the other hand, the lower limit of the melting point, while not particularly limited, is preferably not less than 80° C. When the melting point is 80° C. or more, the bonding layer 4 readily stabilizes at the operating temperature of the insulated wire 1 with bonding layer. The melting point of the (A) component is represented by the peak top temperature of the endothermic peak in “differential scanning calorimetry” (DSC).

In the present disclosure, the polyester resin and polyester elastomer serving as the (B) component consist of a dibasic acid and a polyol, with a block copolymer of a hard segment with high crystallinity and a soft segment with low crystallinity being referred to as a polyester elastomer, and a polymer having a substantially uniform crystallinity as a whole, with no distinction between hard and soft segments, being referred to as a polyester resin.

The bonding layer 4 contains (B) one or more materials selected from a polyester resin and a polyester elastomer. As the (B) component constituting the bonding layer 4, one of a polyester resin and a polyester elastomer may be used or both may be used in combination. When the (B) component is a polyester resin, the adhesive strength on the insulating coating layer 3 is excellent, and when the (B) component is a polyester elastomer, flexibility is excellent. The (B) component preferably has a low melting point and excellent tensile strength.

The melting point of the (B) component is preferably not more than 185° C., and more preferable not more than 160° C. When the melting point is 185° C. or less, an increase in the softening point of the bonding layer 4 can be suppressed, and deterioration of the conductor 2 or the insulating coating layer 3 due to heat generated when bonding is performed is less likely to occur. On the other hand, the lower limit of the melting point, while not particularly limited, is preferably not less than 80° C. When the melting point is 80° C. or more, the bonding layer 4 readily stabilizes at the operating temperature of the insulated wire 1 with bonding layer. The melting point of the (B) component is represented by the peak top temperature of the endothermic peak in “differential scanning calorimetry” (DSC).

The polyester resin is not particularly limited, and examples thereof include polymers that use an aromatic dibasic acid and a short-chain aliphatic glycol as main materials, such as polyethylene terephthalate (PET), polytrimethylene terephthalate, polybutylene terephthalate (PBT), polyethylene naphthalate (PEN), and polybutylene naphthalate (PBN). From the viewpoint of lowering the melting point, the polyester resin constituting the bonding layer 4 is particularly preferably a polymer having a low degree of polymerization or a polymer obtained by copolymerizing an aliphatic dibasic acid, an isophthalic acid, a long-chain or alicyclic glycol, a polyether polyol and the like as a third component when polymerizing the above resin, and reducing the symmetry of the molecules.

The polyester elastomer consists of a block copolymer of hard and soft segments. Examples of the hard segment includes a crystalline polyester such as PET or PBN mentioned above. Example of the soft segment include an aliphatic polyether or an aliphatic polyester.

The tensile breaking strength of the (B) component measured in accordance with JIS K7161 is preferably not less than 19 MPa, and more preferably not less than 20 MPa. Also, although not particularly limited, the tensile breaking strength of the (B) component measured in accordance with JIS K7161 can be set to not more than 50 MPa, and not more than 40 MPa. For example, the tensile breaking strength of the polyester resin can be adjusted as appropriate by the degree of polymerization and the components that are copolymerized, and the tensile breaking strength of the polyester elastomer can be adjusted as appropriate by the type and proportion of the hard and soft segments.

The content of the (B) component is preferably not less than 10 parts per 100 parts total of the (A) and (B) components, and is more preferably not less than 20 parts. When the content of the (B) component is 10 parts or more, the adhesive strength on the insulating coating layer 3 is excellent. On the other hand, in the case where the adherend 5 contains polyolefin, for example, the adhesive strength on the adherend 5 may possibly decrease when the content of the (B) component of the bonding layer 4 is too high. From such a viewpoint, the content of the (B) component is preferably not more than 70 parts per 100 parts total of the (A) and (B) components. In the case where the adherend 5 consists of a polyester resin or a metal and does not contain polyolefin, the bonding layer 4 may contain in excess of 70 parts of the (B) component.

The bonding layer 4 may consist of a single layer or may be formed by laminating a plurality of layers. When formed from a plurality of layers, the adhesive strength between the insulating coating layer 3 and the bonding layer 4 is improved, by disposing a layer containing a large amount of the (B) component as the inner layer close to the insulating coating layer 3, for example. At this time, the sum of the bonding layers as a whole need only contain the (A) and (B) components, and contain 10 to 70 parts of the (B) component.

The bonding layer 4 may contain other components apart from (A) a modified polyolefin and (B) a polyester resin and a polyester elastomer in a range that does not impair the object of the present disclosure. Examples of other components include additives such as an inorganic filler, plasticizer, stabilizer, pigment, antioxidant and tackifier. Also, the bonding layer 4 may contain other polymer components apart from the (A) and (B) components. In the case of containing other polymer components, it is preferable, from the viewpoint of ensuring the adhesive strength of the bonding layer 4 on the insulating coating layer 3 and the adherend 5, that the content of the other polymer components is not more than 30 parts per 100 parts total of the polymer components constituting the bonding layer 4.

Examples of the inorganic filler serving as an additive include silica, diatomaceous earth, glass beads, talc, clay, alumina, a metal oxide such as magnesium oxide, zinc oxide, antimony trioxide or molybdenum oxide, a metal hydroxide such as magnesium hydroxide, a metal carbonate such as calcium carbonate or magnesium carbonate, a metal boric acid such as zinc borate or barium metaborate, and hydrotalcite. These may be used alone, or two or more thereof may be used in combination.

The softening point of the bonding layer 4 is preferably at least lower than the softening point of the insulating coating layer 3. Specifically, the softening point thereof is preferably 80 to 170° C. When the softening point is 170° C. or less, deterioration of the conductor 2 or the insulating coating layer 3 and deformation of the insulating coating layer 3 due to heat when bonding the bonding layer 4 are less likely to occur. On the other hand, when the softening point is 80° C. or more, the bonding layer 4 readily stabilizes at the operating temperature of the insulated wire 1 with bonding layer. The softening point of the bonding layer 4 and the softening point of the insulating coating layer 3 are represented by the peak top temperature of the endothermic peak in “differential scanning calorimetry” (DSC).

A regular insulated wire that is conventionally in common usage can be used for the insulated wire that is located on the inner side of the bonding layer 4. Specifically, an insulated wire having a conductor 2 and an insulating coating layer 3 covering the outer circumference of the conductor 2 need only be used.

Copper is commonly used for the conductor 2, but a metal material such as aluminum or magnesium can also be used apart from copper. These metal materials may be alloys. Examples of other metal materials for forming an alloy include iron, nickel, magnesium, silicon, and a combination thereof. The conductor 2 may be constituted by a single wire or may be constituted by a twisted wire obtained by twisting a plurality of wire strands together.

Illustrative examples of the material constituting the insulating coating layer 3 include polyvinyl chloride (PVC), rubber and polyolefin. These may be used alone, or two or more thereof may be combined for use. Also, various additives may be added to these materials as appropriate.

Generally, the insulating coating is often constituted to include polyvinyl chloride. However, the adhesive strength between polyvinyl chloride and the modified polyolefin that is included in the bonding layer 4 is weak, and, in a conventional bonding layer, delamination tended to occur at the interface between the bonding layer and the insulating coating layer. In the present disclosure, due to the bonding layer 4 containing (A) a modified polyolefin and (B) one or more materials selected from a polyester resin and a polyester elastomer, the bonding layer 4 and the insulating coating layer 3 have an excellent adhesive strength, even when the insulating coating layer 3 contains polyvinyl chloride.

For example, the respective materials constituting the insulating coating layer 3 and the bonding layer 4 can be heated and kneaded and the layers can be formed using an extrusion molding machine. That is, the insulated wire is produced by combining the polymer constituting the insulating coating layer 3 and various additive components that are added as necessary, and extruding the heated and kneaded composition around the conductor 2 with an extrusion molding machine to form the insulating coating layer 3. Thereafter, the insulated wire 1 with bonding layer can be produced, by combining the (A) and (B) components and various additive components that are added as necessary, and extruding the heated and kneaded composition on the outer side of the insulated wire with an extrusion molding machine to form the bonding layer 4. At this time, when the insulating coating layer 3 and the bonding layer 4 are extruded at the same time using a two-layer extrusion molding machine, each layer is laminated in a molten state, and thus the adhesive strength between the insulating coating layer 3 and the bonding layer 4 is excellent.

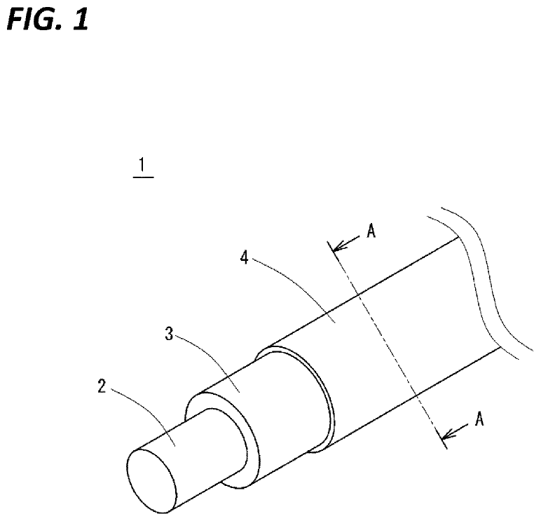

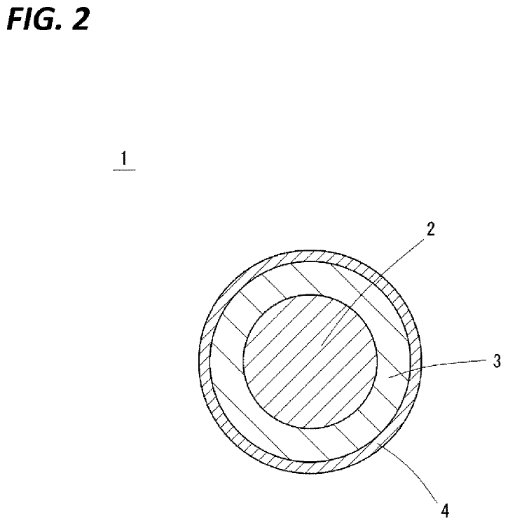

The bonding layer 4 may be formed around the entire circumference in the circumferential direction on the outer side of the insulating coating layer 3 so as to be circular in cross-section, as shown in FIGS. 1 and 2, or may be formed only partially in the circumference direction on the outer side of the insulating coating layer 3. When the bonding layer 4 is formed around the entire circumference on the outer side of the insulating coating layer 3, the adhesive area between the bonding layer 4 and the insulating coating layer 3 increases, and the adhesive strength is excellent. Also, in the case where the bonding layer 4 is circularly formed, even supposing that the bonding layer 4 and the insulating coating layer 3 delaminate, the wire can be retained if within the range of the tensile strength of the bonding layer 4, without the wire immediately becoming detached. Also, the bonding layer 4 does not need to be formed over the entire area in the length direction of the insulated wire.

The thickness of the conductor 2 and the thickness of the insulating coating layer 3 may be in the range of insulated wires that are normally used. On the other hand, the thickness of the bonding layer 4 is preferably from 0.03 to 0.3 mm. When 0.03 mm or more, sufficient bonding surface is readily secured, and when 0.3 mm or less, the thickness of the insulated wire 1 with bonding layer as a whole can be prevented from increasing excessively.

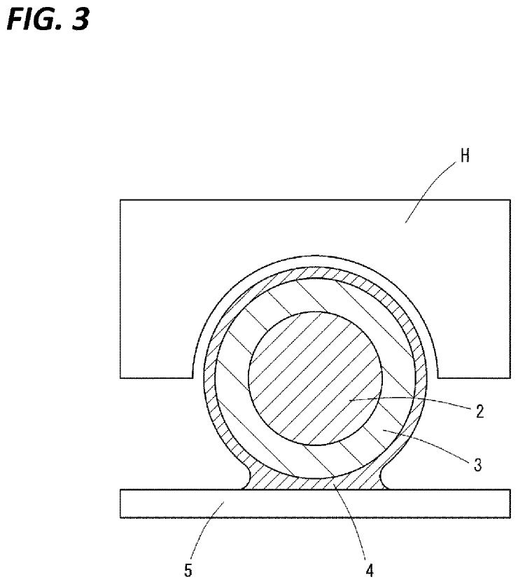

In the insulated wire 1 with bonding layer, the bonding layer 4 can be softened and bonded by being heated. The method of heating is not particularly limited, and examples thereof include generating frictional heat between the bonding layer 4 and the adherend 5 using an ultrasonic generator such as a horn H, as shown in FIG. 3, apart from directly heating the insulated wire 1 with bonding layer or the adherend 5. When heating with an ultrasonic generator, the bonding point can be heated locally, without excessively increasing the temperature of the entire insulated wire 1 with bonding layer, thus enabling deterioration of the conductor 2 or the insulating coating layer 3 due to heat to be suppressed.

At this time, the insulating coating layer 3 and the bonding layer 4 are provided separately, and, by heating at a temperature not more than the softening point of the bonding layer 4 and not more than the softening point of the insulating coating layer 3, deformation of the insulating coating layer 3 can be suppressed at the time of bonding, and the insulated wire 1 with bonding layer can be bonded without compromising performance as an insulated wire.

The adherend 5 to which the insulated wire 1 with bonding layer is bonded is not particularly limited, and examples thereof include a member made of a resin such as polyolefin or polyester and a member made of a metal such as iron, aluminum or stainless steel. Members made of polyolefin are often used in vehicles such as automobiles, and given that the insulated wire 1 with bonding layer according to the present disclosure contains a modified polyolefin in the bonding layer 4, the adhesive strength on polyolefin members is particularly excellent.

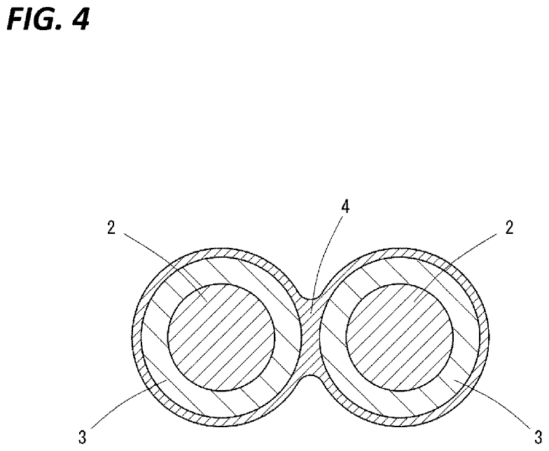

The insulated wire 1 with bonding layer according to the present disclosure is also effective when a plurality of insulated wires with bonding layer are used in a state of being bundled together through bonding, as shown in FIG. 4, apart from for the purpose of fixing wires to the body of automobiles, the casing of devices or the like.

While an embodiment of the present disclosure has been described above in detail, the present invention is not in any way limited to the above embodiment, and various modifications can be made without departing from the gist of the invention.

### WORKING EXAMPLES

Hereinafter, the present disclosure will be described in detail using illustrative examples, but the present invention is not limited by the working examples.

(Preparation of Polyvinyl Chloride Insulating Coating Layer Composition)

100 parts polyvinyl chloride (“TK-1300”, manufactured by Shin-Etsu Chemical), 30 parts plasticizer (n-MOTM “Monocizer W-750”, manufactured by DIC Corporation), 5 parts Ca/Zn heat stabilizer (“ADK STAB RUP-100”, manufactured by Adeka) and 5 parts calcium carbonate (“Super 1700” manufactured by Maruo Calcium) were kneaded using a twin screw extruder to form a polyvinyl chloride insulating coating layer composition.

(Preparation of Polypropylene Insulating Coating Layer Composition)

92 parts polypropylene (“Novatec EC9” manufactured by Japan Polypropylene Corporation), 8 parts thermoplastic elastomer (“Tuftec M1913” manufactured by Asahi Kasei)), 70 parts magnesium hydroxide (“Kisma 5” manufactured by Kyowa Chemical) and 0.5 parts hindered phenolic antioxidants (“Irganox 1010” manufactured by BASF) were kneaded using a twin screw extruder to form a polypropylene insulating coating layer composition.

(Production of Insulated Wire)

An insulated wire was produced by extrusion molding the prepared insulating coating material composition around a twisted conductor having a conductor cross-sectional area of 0.13 mm² at a coating thickness of 0.2 mm

(Preparation of Bonding Layer Composition)

A bonding layer composition was prepared by combining the (A) and (B) components in the proportions shown in Tables 1 to 3, using the following materials, and kneading the combined components using a twin screw extruder. Note that samples 21, 22 and 23 and samples 31 and 32 are each constituted by only one of the (A) component or the (B) component.

(A) Component
Modified PP1 Manufactured by Toyobo: Toyotac M-312 (tensile breaking strength 25.8 MPa)
Modified PP2 Manufactured by Mitsui Chemicals: Admer QE060 (tensile breaking strength 35.0 MPa)

(B) Component
Polyester resin 1 Manufactured by Toyobo: Vyloshot GM-955-RK20 (tensile breaking strength 4.0 MPa, melting point 160° C.)
Polyester resin 2 Manufactured by Toagosei: Aron Melt PES-120L (tensile breaking strength 36.5 MPa, melting point 120° C.)
Polyester elastomer 1 Manufactured by Toray Dupont: Hytrel 3046 (tensile breaking strength 23.4 MPa, melting point 160° C.)
Polyester elastomer 2 Manufactured by Toray Dupont: Hytrel 4047N (tensile breaking strength 19.1 MPa, melting point 182° C.)

(Formation of Bonding Layer)

A bonding layer having a thickness of 0.1 mm was formed, by extrusion molding each bonding layer composition at 200° C. around the entire circumference on the outer side of the insulated wire having an insulating coating layer made of polyvinyl chloride or polypropylene.

(Evaluation)

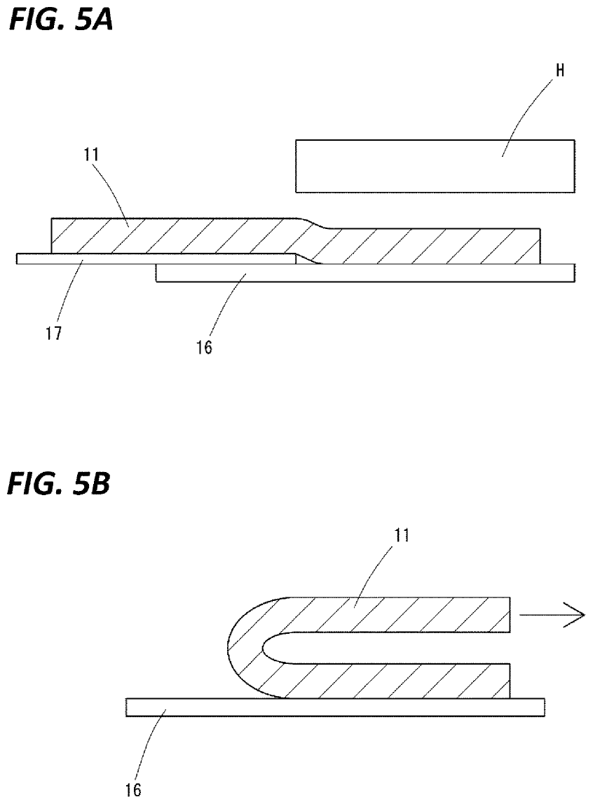

As shown in FIG. 5A, an insulated wire 11 with bonding layer was placed on an adherend 16 so as to come in contact 1 cm from the edge, and the remaining portion thereof was protected with a release sheet 17, after which irradiation with 20-kHz ultrasound was performed from above by the horn H for 10 seconds, and the insulated wire 11 with the bonding layer and the adherend 16 were bonded. The bonded portion was left to cool to room temperature, and, as shown in FIG. 5B, the portion protected with the release sheet was folded back 180 degrees in the direction of the bonded edge and pulled at a speed of 50 mm/sec in the axial direction to peel off the insulated wire 11 with bonding layer. Tables 1 to 3 show the maximum test force exerted at the time of peeling off the insulated wire 11. Note that a plate-like material made of one of polypropylene (PP), polyethylene terephthalate (PET) or aluminum (AL) shown in Tables 1 to 3 was used for the adherend 16.

TABLE 1

| | | | Sample | | | | | |
|---|---|---|---|---|---|---|---|---|
| | | | 1 | 2 | 3 | 4 | 5 | 6 |
| Bonding | (A) | Modified PP1 | 80 | 80 | 80 | 80 | 80 | 80 |
| layer | | Modified PP2 | — | — | — | — | — | — |
| | (B) | Polyester resin 1 | 20 | 20 | 20 | 20 | 20 | 20 |
| | | Polyester resin 2 | — | — | — | — | — | — |
| | | Polyester elastomer 1 | — | — | — | — | — | — |
| | | Polyester elastomer 2 | — | — | — | — | — | — |

| | | | | | | |
|---|---|---|---|---|---|---|
| Insulating coating layer | PVC | PVC | PVC | PP | PP | PP |
| Adherend | PP | PET | AL | PP | PET | AL |
| Max. test force (N) | 8.2 | 9.1 | 7.6 | 12.2 | 13.2 | 11.6 |

TABLE 2

| | | | Sample | | | | | |
|---|---|---|---|---|---|---|---|---|
| | | | 7 | 8 | 9 | 10 | 11 | 12 |
| Bonding | (A) | Modified PP1 | — | 80 | 80 | 80 | 90 | 70 |
| layer | | Modified PP2 | 80 | — | — | — | — | — |
| | (B) | Polyester resin 1 | 20 | — | — | — | 10 | 30 |
| | | Polyester resin 2 | — | 20 | — | — | — | — |
| | | Polyester elastomer 1 | — | — | 20 | — | — | — |
| | | Polyester elastomer 2 | — | — | — | 20 | — | — |

| | | | | | | |
|---|---|---|---|---|---|---|
| Insulating coating layer | PVC | PVC | PVC | PVC | PVC | PVC |
| Adherend | PP | PP | PP | PP | PP | PP |
| Max. test force (N) | 10.2 | 10.6 | 7.2 | 8.1 | 7.4 | 4.1 |

TABLE 3

| | | | Sample | | | | | Sample | |
|---|---|---|---|---|---|---|---|---|---|
| | | | 21 | 22 | 23 | 24 | 25 | 31 | 32 |
| Bonding | (A) | Modified PP1 | 100 | — | — | 95 | 20 | 100 | 100 |
| layer | | Modified PP2 | — | — | — | — | — | — | — |
| | (B) | Polyester resin 1 | — | 100 | — | 5 | 80 | — | — |
| | | Polyester resin 2 | — | — | — | — | — | — | — |
| | | Polyester elastomer 1 | — | — | 100 | — | — | — | — |
| | | Polyester elastomer 2 | — | — | — | — | — | — | — |

| | | | | | | | |
|---|---|---|---|---|---|---|---|
| Insulating coating layer | PVC | PVC | PVC | PVC | PVC | PP | PP |
| Adherend | PP | PP | PP | PP | PP | PET | AL |
| Max. test force (N) | 0.2 | 0.4 | 0.1 | 1.2 | 1.6 | 8.4 | 6.9 |

Samples 1 to 12 in which the bonding layer contains the (A) and (B) components and the content of the (B) component is within the range of the above disclosure exhibit excellent adhesive strength on both the insulating coating layer and the adherend, and the holding force of the wire on the adherend is large. In particular, samples 1 to 8 using polyester resin as the (B) component exhibit particularly excellent adhesive strength on the insulating coating layer and the adherend, and due to delamination being less likely to occur at the interface between the insulating coating layer and the bonding layer and between the adherend and the bonding layer, cohesive failure inside the bonding layer occurred. In such cases, the bonding layer is less likely to fail and the holding force of the wire increases, when a material with a large tensile breaking strength is used for the (A) or (B) component, such as samples 7 and 8. Also, samples 9 and 10 using polyester elastomer as the component (B) have excellent flexibility, despite the holding force of the wire being slightly inferior compared to samples 1 and 8 using polyester resin as the (B) component.

On the other hand, sample 21 in which the bonding layer does not contain the (B) component and sample 24 containing a small amount of the (B) component have inferior adhesive strength on the adherend consisting of polyvinyl chloride. Also, samples 22 and 23 in which the bonding layer does not contain the (A) component and sample 25 containing a large amount of the (B) component are inferior in adhesive strength on the adherend consisting of polypropylene. Note that even if the bonding layer does not contain the (B) component, the adhesive strength between the insulating coating layer and the bonding layer is satisfied and the wire can be sufficiently held on the adherend, when the insulating coating layer consists of polypropylene (samples 31 and 32), although on comparison of samples 31 and 32 with samples 5 and 6, it is evident that the adhesive strength between the bonding layer and the adherend improves and the holding force of the wire improves, due to the bonding layer containing the (B) component in addition to the (A) component.

### LIST OF REFERENCE NUMERALS

1 Insulated wire with bonding layer

2 Conductor

3 Insulating coating layer

4 Bonding layer

5 Adherend

11 Insulated wire with bonding layer

16 Adherend

17 Release sheet

H Horn (ultrasonic generator)

1. An insulated wire with bonding layer comprising:
a conductor;
an insulating coating layer covering an outer circumference of the conductor; and
a bonding layer provided on an outer side of the insulating coating layer and for bonding by heat,
wherein the bonding layer contains:
(A) a modified polyolefin; and
(B) one or more materials selected from a polyester resin and a polyester elastomer, and
the bonding layer contains 10 to 70 parts of the (B) component per 100 parts total of the (A) and (B) components.

2. The insulated wire with bonding layer according to claim 1, wherein the insulating coating layer contains a polyvinyl chloride.

3. The insulated wire with bonding layer according to claim 1, wherein the bonding layer contains (A) the modified polyolefin and (B) the polyester resin.

4. The insulated wire with bonding layer according to claim 1, wherein the bonding layer contains (A) the modified polyolefin and (B) the polyester elastomer.

5. The insulated wire with bonding layer according to claim 1, wherein the bonding layer is provided around an entire circumference in a circumferential direction on the outer side of the insulating coating layer.
